(19) United States
(12) Patent Application Publication
(10) Pub. No.: US 2026/0092624 A1
(43) Pub. Date: Apr. 2, 2026

(54) SELF-LUBRICATING SPHERICAL PLAIN BEARING

(71) Applicant: HYDROMECANIQUE ET FROTTEMENT, ANDREZIEUX BOUTHEON (FR)

(72) Inventor: Emmanuel MASSE, FEURS (FR)

(21) Appl. No.: 19/112,176

(22) PCT Filed: Sep. 20, 2023
(86) PCT No.: PCT/FR2023/051435

§ 371 Date: Mar. 14, 2025

(30) Foreign Application Priority Data
Sep. 23, 2022 (FR) 2209689

(51) Int. Cl. F16C 11/06; F16C 23/04; F16C 33/20

(52) U.S. Cl. CPC F16C 11/068; F16C 11/0614; F16C 23/043; F16C 33/203; F16C 2208/02; F16C 2208/20

(57) ABSTRACT

A self-lubricating ball joint includes a ball and a cage, the ball being rotatably mounted in the cage, the cage being one-piece and including a first stack composed of several layers of composite material, the composite material including a self-lubricating complex including a fabric and a resin impregnating the fabric.

### FIELD OF THE INVENTION

The present invention relates to the technical field of self-lubricating joints, and particular self-lubricating ball joints used in guiding mechanical systems in rotation.

The invention more specifically finds its application for all types of ball joints requiring grease-free operation, i.e. in self-lubricating operation and operating under substantial loads in dynamic mode.

The invention can particularly be used within the scope of an axle system, a transmission system.

### PRIOR ART

A ball joint connection is generally composed of a ball and a cage, the contact between the ball and the cage being spherical. It can have specific features, such as being self-lubricating or allowing more or less play between the ball and the cage.

One constraint arising in the production of a ball joint is the mounting of the ball in the cage. It is therefore known to use a deformable cage, in the form of a part having mechanical weaknesses, or in several parts in order to allow the mounting of the ball in the cage. Thus, the mounting of the ball in the cage can be carried out according to different known ball joint principles which are cited hereinafter:
cage in two parts which are screwed around the ball;
split cage assembled by force with the ball;
cage having notches allowing the ball to enter during mounting;
cage formed by cold working on the ball.

The document EP1608881 describes a self-lubricating ball joint comprising a ball and a cage, the ball being made of metal and being rotatably mounted in the cage. The cage of this self-lubricating ball joint is formed of several parts, with a metal internal part crimped on the ball, an elastomer part placed on the metal internal part, and an external part crimped on the elastomer part, such that the cage surrounds the ball.

A drawback of such a self-lubricating ball joint is that it gives rise to a mounting constraint on account of the fact that it is necessary to provide cage parts which can be cold worked sufficiently such that the cage suitably surrounds the ball. This inevitably gives rise to low mechanical strength of the steel cage on account of the high deformability thereof, but also residual play that is difficult to control. This ball joint furthermore gives rise to complex assembly with the need to carry out crimping and elastomer vulcanisation operations therein so as to limit the play in the self-lubricating ball joint thus mounted. This elastomer system can limit the operation of the ball joint on account of the low shear strength thereof.

Moreover, such a ball joint is composed of materials susceptible to corrosion which can be problematic if the ball joint is used for certain applications subject to corrosion. The maintenance or replacement of this ball joint installed within a system also generates substantial costs as well as system down time.

Applications WO2014169942A1 and EP 2986862B1 describe a ball joint comprising a ball movably mounted in a cage, these two elements being metallic. The cage is here formed of one piece. The ball includes several weakening zones arranged on the edge thereof which makes it deformable, so as to be able to be housed in the cage.

A drawback of such a ball joint is that the deformability of the ball gives rise to a mechanical brittleness at the weakening zones as well as residual play that is difficult to control. Moreover, such a ball joint is composed of a ball and a cage which are made of materials susceptible to corrosion which gives rise to a risk of rapid wear of the ball joint.

Patent application EP0969217 describes a ball joint wherein the ball and the cage are made of composite material. However, such a ball joint has several drawbacks. Firstly, the friction surfaces are composed of a single layer of self-lubricating material which therefore inevitably includes a weakness zone at the junction between the edges of the fabric. Moreover, the ball and the cage are made from a resin reinforced with glass filaments, a material which has a relatively limited mechanical strength in view of the stress sustained by such a ball joint in operation.

Therefore, there is a need to improve the existing situation so as to at least partially resolve the drawbacks of the prior art.

### DISCLOSURE OF THE INVENTION

The invention relates to a self-lubricating ball joint comprising a ball and a cage, said ball being rotatably mounted in said cage, said cage being one-piece, and including a first stack composed of a plurality of layers of composite material, the composite material comprising a self-lubricating complex including a fabric and a resin impregnating this fabric.

A cage which forms a one-piece volume and which includes a stack of several layers of composite material comprising a self-lubricating complex makes it possible to obtain a self-lubricating contact between the cage and the ball, without having a weakening point or mounting direction such as a specific orientation associated with the fracture line as in the case in the prior art for split cages, or due to the position of the notch as is the case in the prior art for notched cages, which makes it possible to improve the mechanical strength with respect to a ball joint of the prior art.

According to an aspect of at least one embodiment of the invention, the volume of the cage can be of constant cross-section.

For this reason, the cage has a continuity over the entire extent of the volume thereof and therefore has no fracture zone, such as a notch or a void.

The benefit of such a volume of constant cross-section is that of providing a friction section, between the cage and the ball, with no discontinuity.

Having several layers also makes it possible to avoid fracture lines formed at the join between the two fabric ends of a single layer.

The thickness of the fabric which forms these layers can be chosen relatively thin, so as to increase the mechanical strength of the self-lubricating complex.

Furthermore, a cage accommodated to the ball, or paired with the ball, makes it possible to obtain controlled play between the ball and the cage.

In particular, this makes it possible to obtain a self-lubricating ball joint with possibly very reduced play between the ball and the cage with respect to the ball joints of the prior art.

A cage accommodated to the ball also makes it possible to prevent wear of the cage by the ball.

Furthermore, and on account of the use of a composite material, the corrosion resistance of the cage is increased with respect to the prior art since such a material has little, or no, susceptibility to corrosion.

The term ball is used here to denote a part in which the shape corresponds to a spherical segment, in other words ball segment, i.e. the shape obtained after cutting, through two planes, which are here parallel, of a ball. More specifically, here, the shape of the spherical segment is obtained after cutting a ball through two symmetrical parallel planes with respect to the centre of the ball.

The cage has an internal surface which also has the shape of a spherical segment. The external surface thereof can have a shape corresponding to a spherical segment obtained by cutting a sphere through two symmetrical parallel planes with respect to the centre of the ball, or a shape corresponding to a cylindrical surface.

According to some embodiments, it could be conceived that the two planes are not parallel and symmetrical with respect to the centre of the ball.

By volume of constant cross-section, it is understood that the cage has a continuity over the entire extent of the volume thereof and therefore has no fracture zone, such as a notch or a void.

According to an aspect of at least one embodiment of the invention, said self-lubricating complex includes at least one strip having a thickness between 20 μm and 200 μm.

This strip of self-lubricating complex is deposited and forms the layers of the first stack.

In this strip of self-lubricating complex, the fabric is impregnated with resin before being deposited to form the layers of the first stack.

It should be noted that the resin can include fillers.

For example, the resin can include lubricant fillers.

The use of strips of self-lubricating complex which are relatively thin makes it possible to control the quantity of self-lubricating complex deposited at a given location on the surface of the cage, and therefore better control the thickness of the first stack at a given point.

For example, this can make it possible to obtain a cage including a first stack having material homogeneity on account of the use of relatively thin strips.

Furthermore, superior resistance to tangential friction forces can be obtained thanks to a cross-weaving of the layers of self-lubricating complex.

For this reason, according to an aspect of at least one embodiment of the invention, said first stack includes cross-weavings of strips of self-lubricating complex according to an angle between 0° and 90°.

Note that the fabric intended to be mixed with the resin can consist of a taffeta, a satin, a twill or a canvas without ruling out other fabric configurations.

According to an aspect of at least one embodiment of the invention, said cage includes a reinforcement shell surrounding said first stack.

The reinforcement shell acts as protection for the cage, by forming an external reinforcement and therefore by providing additional mechanical strength which makes it possible to limit the deformation but also the thermal expansion of the cage during the operation of the self-lubricating ball joint.

According to an aspect of at least one embodiment of the invention, said reinforcement shell is formed from a second stack of several layers including at least one composite material comprising a complex including a fibre and a resin impregnating said fibre.

According to a particular aspect of at least one embodiment of the invention, said complex is chosen from:
a complex including a carbon fibre;
a complex including a glass fibre;
a complex including a Kevlar fibre;
a self-lubricating complex;
a mixture of the above materials.

The fibre can also be a component of a fabric, i.e. the at least one composite material comprises a complex including a fabric composed of a plurality of fibres, and a resin impregnating this plurality of fibres.

Moreover, the resin can be chosen from a thermosetting resin or a thermoplastic resin.

The thermosetting resin can be an epoxy, vinylester, polyester, phenol, or polyimide resin.

The thermoplastic resin can for example be a polyamide (PA6), polyetherketoneketone (PEKK), or polyetheretherketone (PEEK) type resin.

According to an aspect of the invention, there can be between the first and the second stack a certain transition thickness where the fabrics of the first and the second stack are alternating. This makes it possible to avoid an overly distinct interface between the two stacks.

According to an aspect of at least one embodiment of the invention, said ball is composed at least partially of an anticorrosive material.

A ball composed at least partially of an anticorrosive material helps improve the corrosion resistance of the self-lubricating ball joint.

According to an aspect of at least one embodiment of the invention, said anticorrosive material of the ball includes at least one material from:
an anticorrosive metal;
an anticorrosive alloy;
a metal with anticorrosive treatment;
an alloy with anticorrosive treatment,
a material treated by salt bath nitriding;
a composite material.

Alloy denotes a solid homogeneous mixture consisting of a metal and one or more other substances, these other substances optionally being metallic or non-metallic.

Anticorrosive alloys and metals have a natural capability to resist corrosion. Metals and alloys with anticorrosive treatment do not have a natural capability to suitably resist corrosion and therefore undergo a treatment to improve the corrosion resistance thereof.

The invention also relates to the use of a composite material comprising a self-lubricating complex including a fabric and a resin impregnating the fabric, for producing several layers of a first stack of a self-lubricating ball joint cage.

### DESCRIPTION OF THE FIGURES

The invention, as well as the various advantages that it offers, will be understood more easily in the light of the following description of an illustrative and non-limiting embodiment thereof, and the appended drawings wherein:

FIG. 1 is a perspective top view of a self-lubricating ball joint according to an embodiment of the invention;

FIG. 2 is a perspective side view of a self-lubricating ball joint according to the embodiment of FIG. 1;

FIG. 3 is another perspective side view of a self-lubricating ball joint according to the embodiment of FIG. 1;

FIG. 4a is a schematic side view of a self-lubricating ball joint according to the embodiment of FIG. 1;

FIG. 4b is a schematic perspective view of a self-lubricating ball joint according to the embodiment of FIG. 4a;

FIG. 4c is a schematic front view of a self-lubricating ball joint according to the embodiment of FIG. 4a;

FIG. 4d is a schematic sectional side view of a self-lubricating ball joint according to the embodiment of FIG. 4a;

FIG. 5a is a schematic front view of a ball according to the embodiment of FIG. 1;

FIG. 5b is a schematic sectional side view of a ball according to the embodiment of FIG. 5a;

FIG. 5c is a schematic perspective view of a ball according to the embodiment of FIG. 5a;

FIG. 6a is a schematic front view of a first stack according to the embodiment of FIG. 1;

FIG. 6b is a schematic sectional side view of a first stack according to the embodiment of FIG. 6a;

FIG. 6c is a schematic perspective view of a first stack according to the embodiment of FIG. 6a;

FIG. 7a is a schematic front view of a reinforcement shell according to the embodiment of FIG. 1;

FIG. 7b is a schematic sectional side view of a reinforcement shell according to the embodiment of FIG. 7a; and

FIG. 7c is a schematic perspective view of a reinforcement shell of a cage according to the embodiment of FIG. 7a.

### DETAILED DESCRIPTION OF AN EMBODIMENT OF THE INVENTION

The general principle of the invention is based on the implementation of a self-lubricating ball joint comprising a cage and a ball, and having an increased corrosion resistance with respect to the prior art on account of the fact that the cage has little, or no, susceptibility to corrosion. Furthermore, the principle of the invention is also based on the implementation of a self-lubricating ball joint with predetermined controlled play between the cage and the ball.

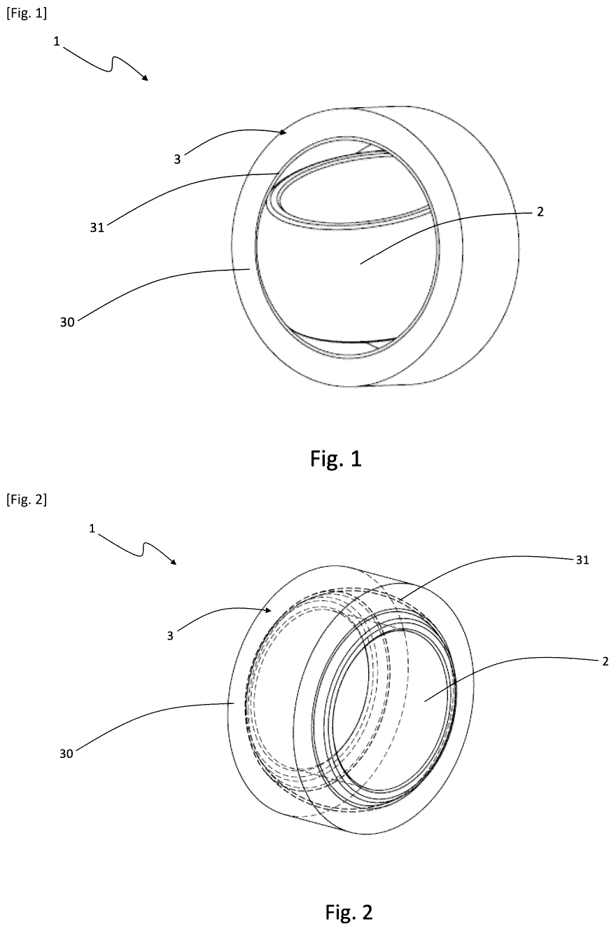

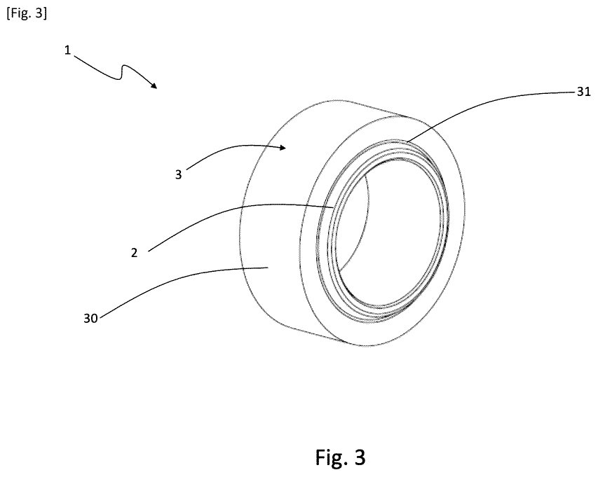

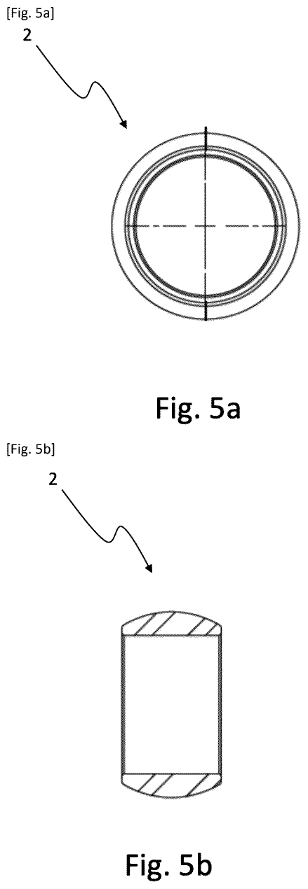

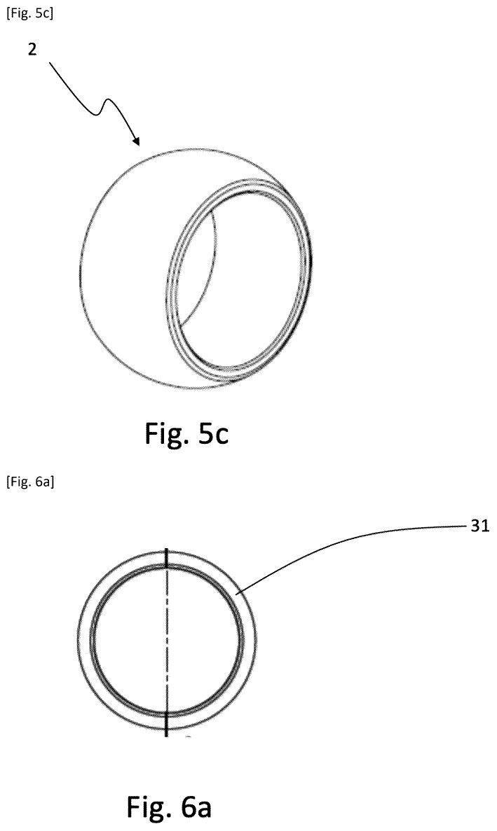

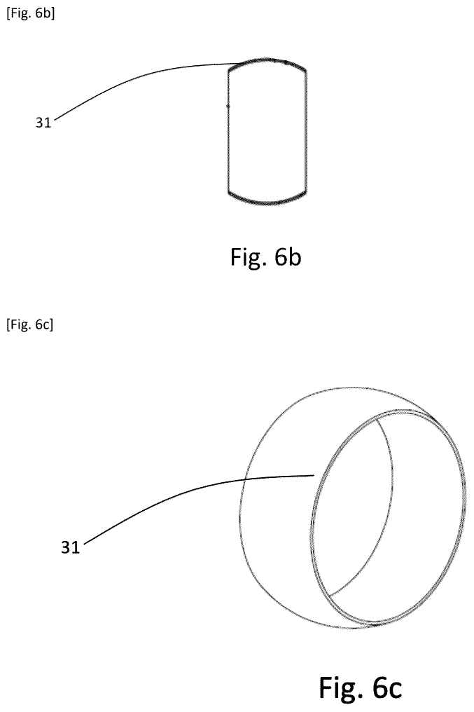

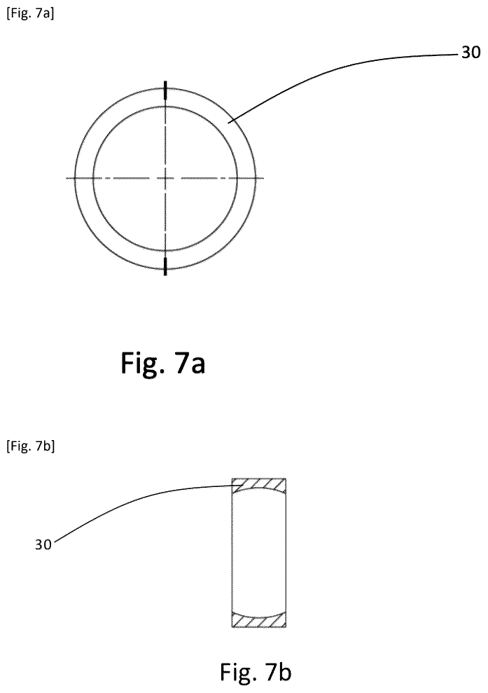

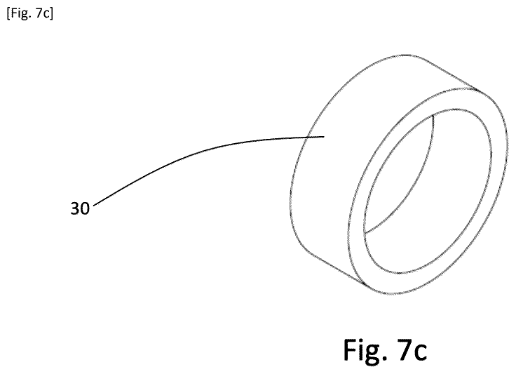

With reference to FIGS. 1 to 7c, an embodiment of a self-lubricating ball joint according to the invention will now be described.

As illustrated by these figures, the self-lubricating ball joint 1 comprises a ball 2 and a cage 3. As can be seen, the ball 2 is rotatably mounted in the cage 3. According to the invention, this cage 3 is one-piece.

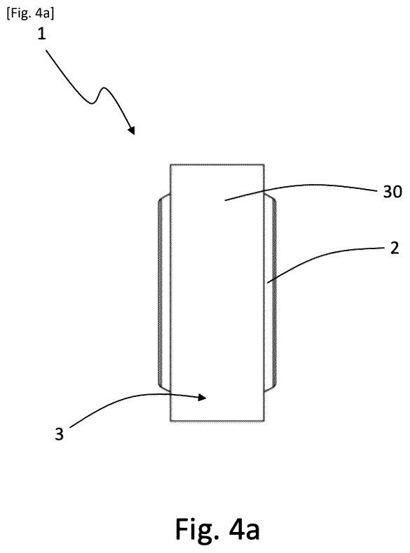

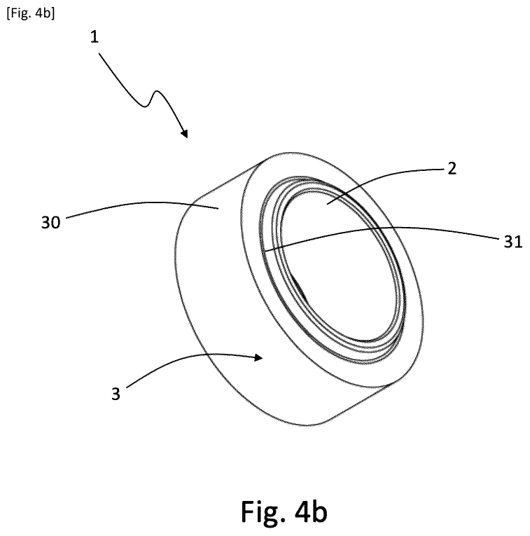

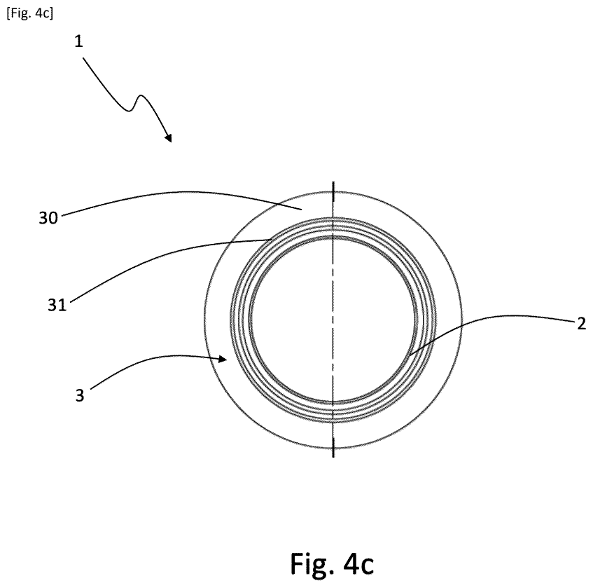

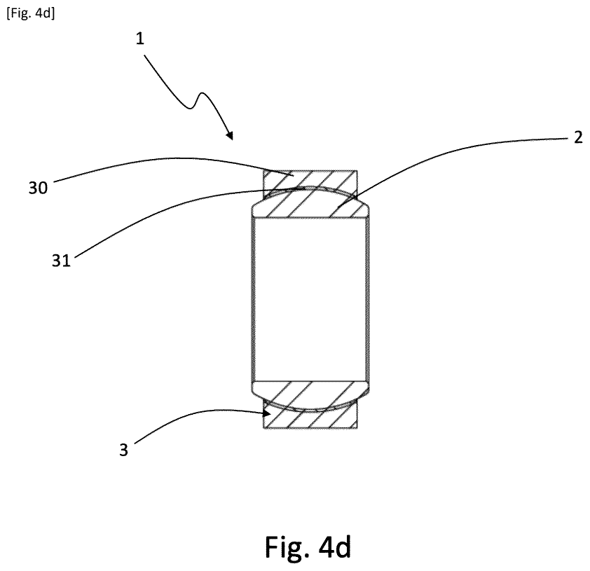

Furthermore, in this embodiment, this cage has a volume of constant cross-section. The cross-section of the cage (30) can for example be seen in FIG. 4d.

In other words, this cage is made of one piece and has no fracture zone, such as a notch or a void.

It includes a first stack 31 composed of several layers of composite material.

This composite material comprises a self-lubricating complex which includes a fabric as well as a resin impregnating this fabric.

Thus, the invention is based on the use of a composite material comprising a self-lubricating complex including a fabric and a resin impregnating the fabric, for producing several layers of a first stack.

The benefit of the use of a composite material for this application is that the corrosion resistance of the self-lubricating ball joint proves to be increased with respect to the prior art since such a material has little, or no, susceptibility to corrosion.

Furthermore, such a composite material makes it possible to obtain a self-lubricating ball joint with very reduced controlled play between the ball and the cage, unlike the self-lubricating ball joints of the prior art, on account of the fact that the cage is accommodated to the ball.

A fabric denotes here a surface made by assembling a plurality of yarns. This fabric forms with the impregnation resin thereof a strip of self-lubricating complex. This self-lubricating complex combines a low friction coefficient and a capability to retain satisfactory friction and mechanical properties when the self-lubricating ball joint is in operation.

The relative configuration of the constituent yarns of the fabric can be chosen so as to form between the various yarns flow channels capable of being filled with the resin.

Among the routine fabric configurations, it is possible to use a fabric with a twill 2/2 configuration formed from interweaving pairs of weft yarns and pairs of warp yarns.

It is also possible to use a fabric with a taffeta configuration which has a relatively high resistance to maximum interlacing of the warp and weft yarns.

The fabric is, in this embodiment, a fabric made of polyester.

The strips of self-lubricating complex are deposited and form the layers of the first stack 31.

The resin can, for example, be a thermosetting or thermoplastic resin.

The thermosetting resin can be an epoxy, vinylester, polyester, phenol, or polyimide resin.

In this embodiment, the self-lubricating complex is presented in the form of strips having a thickness between 20 μm and 200 μm.

The resin used is, in this embodiment, an epoxy resin charged with lubricant particles.

Moreover, according to the embodiments, the self-lubricating complex is arranged such that the first stack 31 includes cross-weavings of strips of self-lubricating complex according to an angle between 0°and 90°.

In other words, several strips of self-lubricating complex can be overlaid, a strip forming an angle between 0 and 90°with a successive strip.

In the embodiment illustrated, the first stack 31 includes cross-weavings of strips of self-lubricating complex according to an angle greater than or equal to 5°, and less than 90°.

As can be seen in the different figures, the cage 3 furthermore includes a reinforcement shell 30 surrounding the first stack 31.

In other words, the reinforcement shell forms an external reinforcement, also known as sheath or armour, surrounding the first stack 31. This reinforcement shell 30 is formed from a second stack of several layers including at least one composite material comprising a complex including a fibre and a resin impregnating this fibre.

In this embodiment, this complex is chosen from:
a complex including a carbon fibre;
a complex including a glass fibre;
a complex including a Kevlar fibre;
a self-lubricating complex;
a mixture of the above materials.

It should be noted that the layers can at least contain a composite material comprising a complex including a fabric, composed of a plurality of fibres and a resin impregnating these fibres composing the fabric.

As regards the resin, in the same way as for the cage, it can, for example, be chosen from thermosetting or thermoplastic resins.

The thermosetting resin can be an epoxy, vinylester, polyester, phenol, or polyimide resin.

The purpose of this reinforcement shell is to protect the cage when this self-lubricating ball joint is stressed inside a system in operation. In other words, it forms an external reinforcement and provides additional mechanical strength which makes it possible to limit the deformation but also the thermal expansion of the cage during the operation of the self-lubricating ball joint, on account of the fact that under operating conditions, the stress of the self-lubricating ball joint gives rise to a temperature rise of the cage and ball. The reinforcement shell thus makes it possible to limit deformation and expansion so as to control the play between the cage and the ball.

In this embodiment, the ball is composed at least partially of an anticorrosive material so as to obtain a self-lubricating ball joint which has little or no susceptibility to corrosion.

Having a ball composed at least partially of an anticorrosive material helps improve the corrosion resistance of the self-lubricating ball joint, and therefore improve the service life of the self-lubricating ball joint.

This anticorrosive material includes at least one material from:
an anticorrosive metal;
an anticorrosive alloy;
a metal with anticorrosive treatment
an alloy with anticorrosive treatment
a material treated by salt bath nitriding, or
a composite material.

For example, the anticorrosive alloy can be a stainless steel.

Such a self-lubricating ball joint with a ball made of a material anticorrosive treatment can be produced by means of a manufacturing method comprising a step of anticorrosive treatment of a material composing said ball.

This treatment step can for example comprise a salt bath nitriding step so as to improve the corrosion resistance capabilities of the material.

According to an alternative, the treatment step can comprise a nitrocarburising step.

This manufacturing method can comprise, according to a specific embodiment, a step of testing the corrosion resistance of the material obtained.

Then, this manufacturing method comprises a step of assembling the ball and the cage so as to form the self-lubricating ball joint.

1. A self-lubricating ball joint comprising:
a one-piece cage including a first stack composed of several layers of composite material, the composite material comprising a self-lubricating complex including a fabric and a resin impregnating said fabric; and
a ball rotatably mounted in the cage.

2. The self-lubricating ball joint according to claim 1, wherein said self-lubricating complex includes at least one strip having a thickness between 20 μm and 200 μm.

3. The self-lubricating ball joint according to claim 1, wherein said first stack includes cross-weavings of strips of self-lubricating complex according to an angle between 0° and 90°.

4. The self-lubricating ball joint according to claim 1, wherein said cage includes a reinforcement shell surrounding said first stack.

5. The self-lubricating ball joint according to claim 4, wherein said reinforcement shell is formed from a second stack of several layers including at least one composite material comprising a complex including a fiber and a resin impregnating said fiber.

6. The self-lubricating ball joint according to claim 5, wherein said complex is chosen from:
a first complex including a carbon fiber;
a second complex including a glass fiber;
a third complex including a Kevlar fibre,
a fourth, self-lubricating, complex, and
a mixture of the first complex, the second complex, the third complex, and the fourth complex.

7. The self-lubricating ball joint according to claim 1, wherein said ball is composed at least partially composed of an anticorrosive material.

8. The self-lubricating ball joint according to claim 7, wherein said anticorrosive material of said ball includes at least one material from:
an anticorrosive metal,
an anticorrosive alloy,
a metal with anticorrosive treatment,
an alloy with anticorrosive treatment,
a material treated by salt bath nitriding, and
a composite material.

9. A method of forming a self-lubricating ball joint cage, the method comprising:
producing several layers of a first stack of the self-lubricating ball joint cage using a composite material comprising a self-lubricating complex including a fabric and a resin impregnating said fabric.
